(19) United States
(12) Patent Application Publication
(10) Pub. No.: US 2010/0142531 A1
(43) Pub. Date: Jun. 10, 2010

(54) METHOD AND SYSTEM FOR ENHANCING ROUTING IN MULTIPROTOCOL LABEL SWITCHING (MPLS)

(75) Inventors: Ankit Kansara, Bangalore (IN); Priyanka Gupta, Bangalore (IN)

Correspondence Address: THE FARRELL LAW FIRM, LLP, 290 Broadhollow Road, Suite 210E, Melville, NY, 11747, US

(73) Assignee: Samsung Electrics Co., Ltd., Suwon-si (KR)

(21) Appl. No.: 12/628,612

(22) Filed: Dec. 1, 2009

(30) Foreign Application Priority Data
Dec. 1, 2008 (IN) 3008/CHE/2008

(51) Int. Cl. H04L 12/56

(52) U.S. Cl. 370/392

(57) ABSTRACT

A method and a system for enhancing routing in MultiProtocol Label Switching (MPLS) are provided. The method includes obtaining signaling protocol information from a plurality of routers and storing the signaling protocol information. Further, the method includes receiving a request from a router. The request includes a destination address, a signaling protocol and at least one other constraint. Further, the method also includes determining a Signaling Protocol specific Constrained based Explicit Route (SPCER) to the destination router from the signaling protocol information, and providing the SPCER to the router.

### PRIORITY

This application claims priority under 35 U.S.C. §119(a) to an Indian Patent Application filed in the Indian Intellectual Property Office on Dec. 1, 2008 and assigned Serial No. 3008/CHE/2008, the contents of which are incorporated herein by reference.

### BACKGROUND OF THE INVENTION

1. Field of the Invention

The present disclosure relates generally to the field of communication protocol and more particularly to enhancing routing in MultiProtocol Label Switching (MPLS).

2. Description of the Related Art

A conventional communication network may include a plurality of routers, and that the data packets may travel from one router to another. In calculating shortest path in a conventional communication network, various constraints can be specified to in order to calculate a desired path. The specified constraints may include bandwidth, administrator group, hop limit, Traffic Engineering (TE) metric, include and exclude address, hold priority and setup priority. However, the routers in the network are not aware of signaling protocols supported by a destination router and intermediate routers in the network. Further, results of the shortest route for a desired signaling protocol may provide list of next hop-over routers, where the signaling protocol may be different. Moreover, conventional methods use a trial and error approach to calculating a shortest path, resulting in excess consumption of bandwidth and time, resources, and increase in processing overhead.

In light of the foregoing discussion there is a need for an efficient technique for enhancing routing in MPLS.

### SUMMARY OF THE INVENTION

Embodiments of the present disclosure described herein provide a method and system for enhanced routing.

One aspect of the present invention provides a method for enhanced routing. The method includes obtaining signaling protocol information from a plurality of routers. The method also includes storing the signaling protocol information. Further, the method includes receiving a request from a router, wherein the request includes constraints including a destination address, a signaling protocol, and at least one other constraint. Further, the method also includes determining a Signaling Protocol specific Constrained based Explicit Route (SPCER) to the destination router from the signaling protocol information and providing the SPCER to the router.

Another aspect of the present invention provides a system for enhanced routing. The system includes a plurality of routers for sending signaling protocol information and a storage device for storing the signaling protocol information. The system also includes a path computation element for receiving a request from a router, wherein the request includes constraints including a destination address, a signaling protocol, and at least one other constraint, determining a Signaling Protocol specific Constrained based Explicit Route (SPCER) to the destination router from the signaling protocol information and providing the SPCER to the router.

### BRIEF DESCRIPTION OF THE DRAWINGS

The above and other aspects, features and advantages of embodiments of the present invention will be more apparent from the following description taken in conjunction with the accompanying drawings, in which:

FIG. 1 is a block diagram of a network environment according to embodiments of the present invention;

FIG. 2 is a flowchart illustrating a method for enhancing routing in multiprotocol label switching, in accordance with an embodiment of the present invention;

FIG. 3 is a flow diagram illustrating a process of calculating a Signaling Protocol specific Constrained based Explicit. Route (SPCER), in accordance with one embodiment.

Persons skilled in the art will appreciate that elements in the figures are illustrated for simplicity and clarity and may have not been drawn to scale. For example, the dimensions of some of the elements in the figures may be exaggerated relative to other elements to help to improve understanding of various embodiments of the present disclosure.

### DETAILED DESCRIPTION OF EMBODIMENTS OF THE INVENTION

The terms and words used in the following description and claims are not limited to the bibliographical meanings, but are merely used by the inventor to enable a clear and consistent understanding of the invention. Accordingly, it should be apparent to those skilled in the art that the following description of the embodiments of the present invention are provided for illustration purpose only and not for the purpose of limiting the invention as defined by the appended claims and their equivalents. Relational terms such as first and second, etc., may be used to distinguish one entity from another entity, without necessarily implying any actual relationship or order between such entities.

Embodiments of the present invention described herein provide a method and system for enhancing routing in Multiprotocol Label Switching (MPLS).

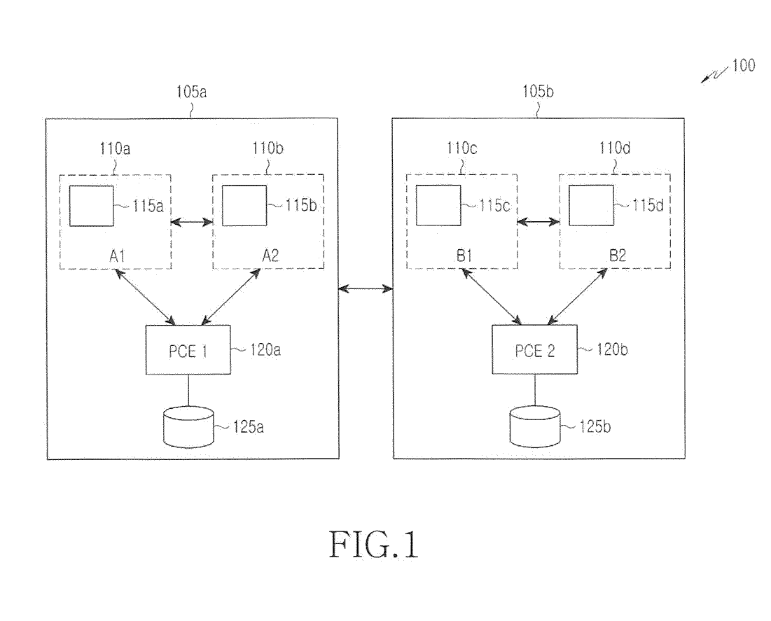

FIG. 1 is a block diagram of a network environment 100, in accordance with various embodiments of the present invention.

The network environment 100 includes at least one Autonomous System (AS), for example AS 105a and AS 105b. The AS 105a electronically communicates with the AS 105b.

Each AS can include one or more areas, for example an area 110a and an area 110b are included in the AS 105a, and an area 110c and an area 110d are included in the AS 105b. The areas electronically communicate with each other. Each of the areas can operate through different or similar protocols. Each area can also include one or more routers. For example, a router 115a is included in area 110a, a router 115b is included in area 110b, a router 115c is included in area 110c, and a router 115d is included in area 110d.

Each AS can also include one or more Path Computation Elements (PCEs). For example a PCE1 120a is included in the AS 105a, and a PCE2 120b is included in the AS 105b. In accordance with other embodiments of the present invention, routers can also function as PCEs.

Each router can support various protocols. For example, the router 115b can support a first protocol for communicating with the router 115a and a second protocol for communicating with the router 115c. Meanwhile, the interface between the router 115b and the router 115a supports one protocol.

Examples of ASs include, but are not limited to, multihomed ASs, stub Ass, and transit ASs. Examples of the routers include, but are not limited to, internal routers, Area Boundary Routers (ABRs), backbone routers, and AS Boundary Routers (ASBRs).

According to some embodiments of the present invention, a common router may be positioned between any two areas. The common router can be defined as a router that is aware of protocols running in both areas. For example, the functions of PCE1 120a can be performed by a common router.

The PCE1 120a has access to a storage device 125a, and the PCE2 120b has access to the storage device 125b. The storage device 125a stores information regarding all of the protocols that are running on each of the routers in AS 105a. Similarly, the storage device 125b stores information regarding all of the protocols that are running on each of the routers in AS 105b. The PCE1 120a can send a path computation to PCE2 120b to calculate a route to a router with an inter-PCE communication mechanism. The PCE2 120b can also forward the request to some other PCE to obtain the route if the PCE2 is not able to supply a complete path for requested service.

In some embodiments, the network environment 100 can also include an Intermediate System-Intermediate System (IS-IS) system. Information of protocols running on routers of an IS-IS system can also be stored in the storage device.

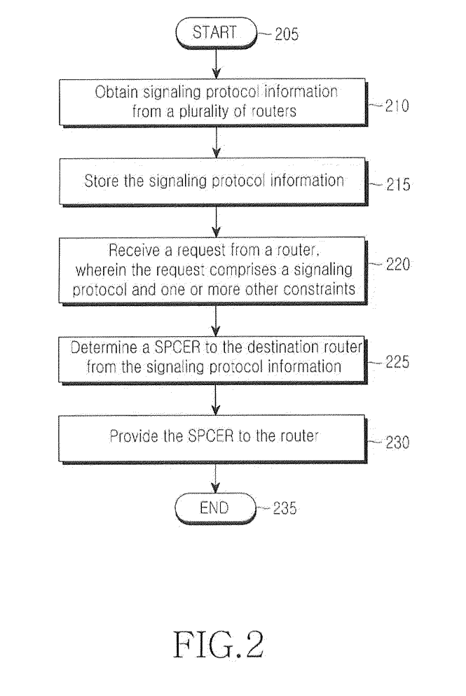

FIG. 2 is a flowchart illustrating a method for enhancing routing, in accordance with an embodiment of the present invention.

The method starts at step 205. At step 210, signaling protocol information from a plurality of routers is obtained. The signaling protocol information is used to identify the state of a connection between two routers. The plurality of routers can be in multiple areas, ASs, or IS-IS systems. The routers may be Open Shortest Path First (OSPF) enabled routers or IS-IS enabled routers. The signaling protocol information includes information protocols supported and enabled in each router. The protocols include support for one or more functionalities. Examples of the functionalities include, but are not limited to, a communication over client-server session and a peer-to-peer communication system. Examples of the protocols include, but are not limited to, a Resource Reservation Protocol-Traffic Engineering (RSVP-TE) protocol and a Constraint based Routing Label Distribution Protocol (CR-LDP).

Obtaining the signaling protocol information may include using OSPF Traffic Engineering (OSPF-TE). The OSPF can be notified of the signaling protocol running on the interface of the router. The OSPF can also send and receive a sub-Type Length Value (TLV). The sub-TLV is explained in conjunction with Table 1 and Table 2.

TABLE 1

| | |
|---|---|
| Type (10) | Length (1 octect) |

Reserved

| | | |
|---|---|---|
| Bit Position | 0 | 1 |

TABLE 2

| Bit Position | Value | Meaning |
|---|---|---|
| 0 | 0 | RSVP-TE is not enabled |
| | 1 | RSVP-TE is enabled |
| 1 | 0 | CR-LDP is not enabled |
| | 1 | CR-LDP is enabled |

Table 1 includes Type 10, which is an Opaque 10 Link State Advertisement (LSA) type. There are two bit-positions corresponding to RSVP-TE and CR-LDP, respectively. A “1” in a bit position corresponding to a protocol indicates that the router supports the protocol.

The sub-TLV is added to link TLV to carry the signaling protocol enabled on the interface.

At step 215, signaling protocol information is stored, in a database. The database can include information bandwidth, administration group and signaling protocol associated with the router. The database is built by the OSPF according to IS-IS routing protocol. The OSPF collects packets from each router in the area. The OSPF utilizes Link State Advertisements (LSA) to distribute signaling protocol and at least one other constraint associated with the routers. The LSA are maintained in each router through a Link State DataBase (LSDB). The LSDB can be updated frequently.

At step 220, a request is received from a router. The router may use Resource ReSerVation Protocol (RSVP) to request resources for a data flow. A request is received at the Constrained Shortest Path First (CSPF) running on the router. The request includes a destination address, the signaling protocol, and at least one other constraint. The at least one constraint can include bandwidth, an admin-group, a hop limit, a TE-metric, include & exclude addresses, a hold priority, and a setup priority. The destination address corresponds to a destination router.

At step 225, a Signaling Protocol specific Constrained based Explicit Route (SPCER) to the destination router from the signaling protocol information is determined. The CSPF computes the SPCER based on the destination address, the signaling protocol, and at least one other constraint and returns the list of next hops to the RSVP. The CSPF uses information stored in the database to fetch the list. Since the database stores signaling protocol information, the list includes information regarding routers that support the signaling protocols. Further, the routers can send a packet to the destination router when the signaling protocol between the routers and the destination router mismatch.

At step 230, the SPCER is provided to the router. The RSVP signals and reserves resources for data flow based on the list. The data packet is now routed over an established Label-Switched Path (LSP). The Method is completed at step 235.

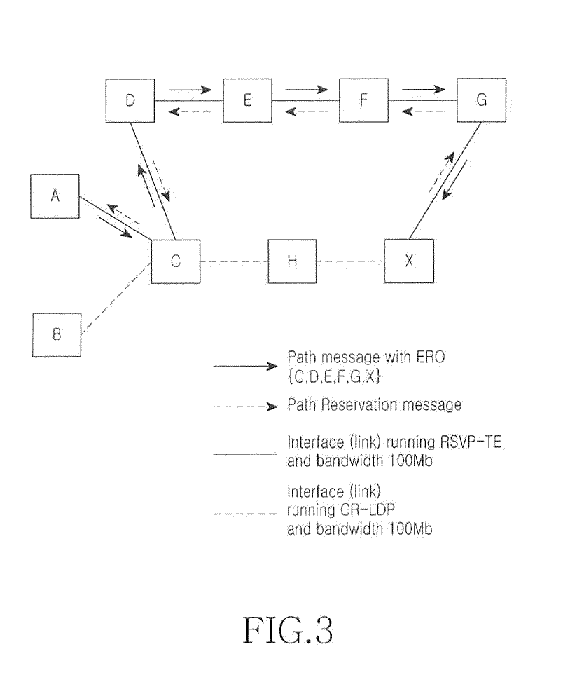

FIG. 3 is a flow diagram illustrating an example for a process of determining SPCER, in accordance with an embodiment of the present invention.

Information about a signaling protocol enabled over an interface is carried in an OSPF-TE type 10 opaque LSA. The routers flood OSPF-TE type 10 opaque LSA carrying the signaling protocol on each of the routers' connected interfaces. Each of the routers in an area has complete knowledge about TE topology based on the flooding.

Referring to FIG. 3, after the flooding process, router A has TE topology database. The router A also includes the signaling protocol enabled over each of the routers interlace in the network. An RSVP-TE running on router A requests a CSPF to calculate route towards egress X with at least one other constraint. The at least one other constraint can be, for example, a bandwidth of 50 Mb and a maximum number of hops set to 5. The CSPF can also include a signaling protocol enabled in the interface as one of the constraints for calculating SPCER. In the present example, the CSPF considers the protocol requesting the route calculation as a default constraint. The link in the path ‘A-C-D-E-F-G-X’ uses an RSVP-TE protocol, and the link in the path ‘B-C-H-X’ uses a CR-LDP protocol. In the present example, RSVP-TE is considered as default constraint. The information of signaling protocols and TE topology can be checked in a PCE. The CSPF sends a request to the PCE for the information based on signaling protocol and at least one other constraint. The CSPF utilizes the information of signaling protocols and TE topology to calculate the SPCER.

The RSVP-TE can send a request for the SPCER to the PCE. The PCE can use the signaling protocol information and a TE database to compute the route towards a destination with given constraints.

The CSPF calculates the SPCER towards egress router X and the list of hops to the egress router-X. In the present example illustrated in FIG. 3, the list of hops is ‘C-D-E-F-G-X’. The calculated path satisfied the constraints bandwidth, max hops and signaling protocol. The calculated path is sent by the RSVP-TE to the next hop router ‘C’ and a TE tunnel is successfully established by RSVP-TE towards egress router X based on the protocol operation. A path reservation message is sent to the router A upon a successful reservation of the desired path.

It will be appreciated a method according to the present invention can be extended to calculate the SPCER for an inter area Label Switched Path (LSP). The inter area LSP can span across multiple ASs or within a single AS.

While the present invention has been described with reference to specific embodiments, it will be apparent to a person ordinary skilled in the art that various modifications and changes can be made, without departing from the scope of the present disclosure, as set forth in the claims below. Accordingly, the specification and figures are to be regarded as illustrative examples of the present invention. All such possible modifications are intended to be included within the scope of present disclosure.

What is claimed is:

1. A method for enhancing routing, the method comprising:
obtaining signaling protocol information from a plurality of routers;
storing, by a storage device, the signaling protocol information;
receiving a request from a router, wherein the request comprises constraints including a destination address, a signaling protocol, and at least one other constraint;
determining, by a path computation element, a Signaling Protocol Specific Constrained based Explicit Route (SPCER) to the destination router according to the signaling protocol information; and
providing the SPCER to the router.

2. The method of claim 1, wherein the signaling protocol includes at least one of a Resource ReSerVation Protocol-Traffic Engineering (RSVP-TE) protocol and a Constraint based Routing Label Distribution Protocol (CR-LDP).

3. The method of claim 1, wherein the plurality of routers includes at least one of a Open Shortest Path First (OSPF) router and an Intermediate System-Intermediate System (IS-IS) enabled router.

4. The method of claim 1, wherein the plurality of routers correspond to at least one of an autonomous system and an intermediate system-intermediate system.

5. The method of claim 1, wherein the plurality of routers are in at least two different areas.

6. The method of claim 1, wherein the obtaining the signaling protocol information comprises receiving the signaling protocol information along with the at least one other constraint from the plurality of routers.

7. The method of claim 1, wherein the obtaining is based on Open Shortest Path first-Traffic Engineering (OSPF-TE) type 10 opaque Link State Advertisement (LSA) and Intermediate System-Intermediate System Traffic Engineering (IS-IS TE) link advertisement.

8. The method of claim 1, wherein the determining is based on Constrained Shortest Path First (CSPF) determination scheme.

9. A system for enhancing routing, the system comprising:
a plurality of routers for sending signaling protocol information;
a storage device for storing the signaling protocol information sent from the plurality of routers; and
a path computation element for receiving, from a router, a request comprising constraints including a destination address, a signaling protocol, and at least one other constraint, for determining a Signaling Protocol specific Constrained based Explicit Route (SPCER) from the router to the destination router according to the signaling protocol information, and for providing the SPCER to the router.

10. The system of claim 9, wherein the signaling protocol includes at least one of a Resource ReSerVation Protocol-Traffic Engineering (RSVP-TE) protocol and a Constraint based Routing Label Distribution Protocol (CR-LDP).

11. The system of claim 9, wherein the plurality of routers includes at least one of a Open Shortest Path First (OSPF) router and an Intermediate System-Intermediate System (IS-IS) enabled router.

12. The system of claim 9, wherein the plurality of routers correspond to at least one of an autonomous system and an intermediate system-intermediate system.

13. The system of claim 9, wherein the plurality of routers are in at least two different areas.

14. The system of claim 9, wherein the signaling protocol information is sent along with the at least one other constraint from the plurality of routers.

15. The system of claim 9, wherein the signaling protocol information is sent based on Open Shortest Path first-Traffic Engineering (OSPF-TE) type 10 opaque Link State Advertisement (LSA) and intermediate System-Intermediate System Traffic Engineering (IS-IS TE) link advertisement.
